(19) United States
(12) Patent Application Publication
(10) Pub. No.: US 2012/0162997 A1
(43) Pub. Date: Jun. 28, 2012

(54) LIGHT SIGNAL

(75) Inventors: Joerg Birkholz, Drasdo (DE); Rolf Eckl, Berlin (DE); Uwe Frost, Berlin (DE); Kay Koester, Fredersdorf (DE); Zeljko Marincic, Berlin (DE); Norbert Poepplow, Eichwalde (DE)

(73) Assignee: SIEMENS AKTIENGESELLSCHAFT, MUENCHEN (DE)

(21) Appl. No.: 13/393,282

(22) PCT Filed: Jul. 27, 2010
(86) PCT No.: PCT/EP10/60881

§ 371 Date: Feb. 29, 2012

(30) Foreign Application Priority Data
Aug. 31, 2009 (DE) 10 2009 039 704.3

(51) Int. Cl. F21V 5/04

(52) U.S. Cl. 362/311.06

(57) ABSTRACT

A light signal contains a semiconductor light source and an optical system for representing signal aspects (properties), especially on rail-bound traffic routes. In order to obtain the advantageous properties of filament light signals, especially with respect to the beam spread in horizontal direction, the semiconductor light source is configured as a point light source, especially as an individual LED—light-emitting diode—or as an individual HLED—high current LED—and the optical system has an axially symmetric cylindrical lens and a rotationally symmetric convex lens, especially a Fresnel lens.

The invention relates to a light signal with a semiconductor light source and an optical system for representing signal aspects, in particular in rail-bound transport routes.

The explanations below substantially relate to illuminated signs or light signals for representing signal aspects in rail-bound transport routes, without the claimed inventive subject matter intending to be restricted to this application.

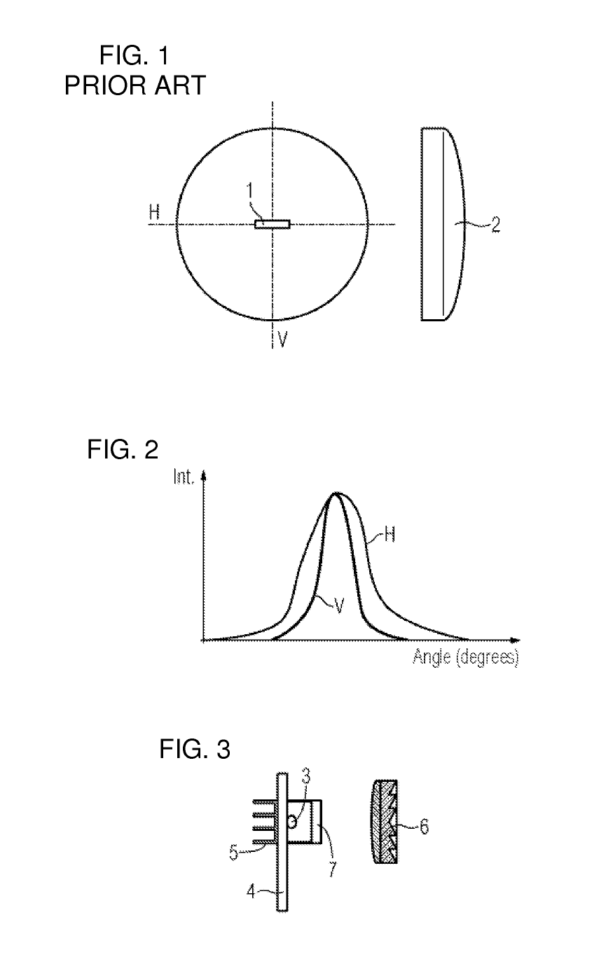

In the case of the light signal of a known design illustrated schematically in FIG. 1, an incandescent filament 1 of an incandescent lamp is used as light source. The incandescent filament light signal substantially comprises the incandescent lamp and an optical system 2 with a solid lens or a stepped lens and a color filter glass (not illustrated) for realizing the conventional signal colors.

FIG. 2 illustrates the emission profiles corresponding to the position of the incandescent filament 1 in the horizontal direction H and the vertical direction V. The figure shows that the beam expands in the horizontal direction H. This emission profile, which widens in the horizontal direction H and, in particular in the far region, brings about an improvement in the visibility of the signal is produced automatically in the case of incandescent lamps owing to the elongated geometry of the incandescent filament 1.

Modern and for many reasons preferable semiconductor light sources have a quite different emission characteristic than the incandescent filament 1, however, with the result that it is desirable to reproduce the incandescent filament geometry by providing a certain grouping of a plurality of semiconductor light sources, in particular LEDs (light-emitting diodes). In addition to the widened horizontal emission profile, the LED arrangement needs to have complete illumination of a special optical system, homogeneous imaging or homogeneity of the light spot in the far field and a minimum luminous intensity. These requirements can only be achieved with a considerable amount of complexity as regards the driver assemblies and the LED and lens matrices.

The invention is based on the object of specifying a light signal of the generic type, in which the abovementioned disadvantages are markedly reduced, with in particular a reduction in the components being desirable.

According to the invention, the object is achieved in that the semiconductor light source is in the form of a point light source, in particular in the form of an individual LED or in the form of an individual HLED (high-current LED), and in that the optical system has an axially symmetrical cylindrical lens and a rotationally symmetrical focusing lens, in particular a Fresnel lens.

The horizontal beam expansion for the light of the point light source is in this case achieved via the cylindrical or cylinder-like end face of the cylindrical lens. The setting of the horizontal direction is realized by a fixed installation position with respect to the signal shield alignment. The radius of the cylindrical lens is a multiple of the lens focal width, as a result of which the areal lens illumination, the collimating effect of the rotationally symmetrical focusing lens and the homogeneity of the light spot in the far field remain virtually unimpaired. The point light source used is preferably a high-intensity HLED with a Lambertian emission response. The combination comprising point light source/cylindrical lens/focusing lens results in a marked cost reduction in comparison with the known combination comprising LED matrix/lens matrix, by means of which the incandescent filament of an incandescent lamp is intended to be replicated. Since the beam shaping of the point light source by means of the optical system comprising the cylindrical lens and the focusing lens corresponds to the emission response of the incandescent lamp signal, existing additional optical elements can continue to be used. The HLED in the form of an individual component results in a simplified printed circuit board layout and a space saving, with the result that a separate light source module is no longer necessary. A further advantage is that different point light sources can be combined with a single optical system, while the LED matrix and lens matrix need to be matched precisely to one another. The number of optical and electrical components is considerably reduced in comparison with the matrix variant. The driver assembly is simpler and reduced logistical complexity ultimately results.

In accordance with claim 2, provision is made for the optical system comprising a cylindrical lens and a focusing lens to be in the form of an integral plastic injection-molded part. This results in a further simplification with a considerable cost advantage.

The invention will be explained in more detail below with reference to the illustrations in the figures, in which:

FIG. 1 shows an incandescent filament light signal,

FIG. 2 shows a horizontal and vertical emission profile,

FIG. 3 shows a light signal of the claimed design, and

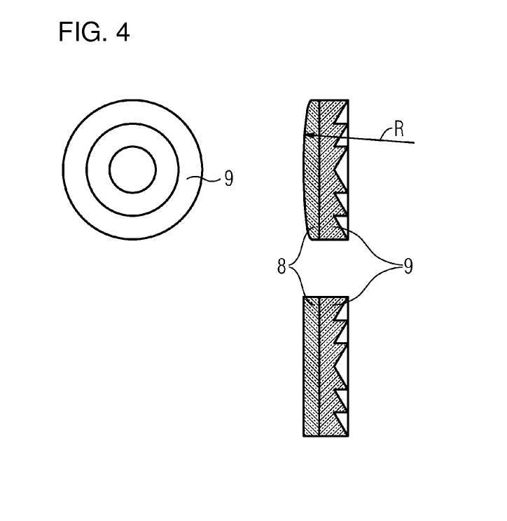

FIG. 4 shows an optical system for a light signal as shown in FIG. 3.

In contrast to the above-described incandescent filament light signal illustrated in FIG. 1, in the case of the light signal according to the invention which is illustrated in FIG. 3, a single white HLED (high-current LED) 3 is used as point light source. This is arranged on a printed circuit board 4 with a heat sink 5. In order to realize different signal colors, a color filter sheet arrangement 7 is provided between the HLED 3 and an optical system 6. In this case, the optical system 6 is in the form of an integral lens combination, which is illustrated in plan view and in two side views in FIG. 4. Preferably, the optical system 6 comprises plastic injection molding, wherein an axially symmetrical cylindrical lens form 8 on the light-entry side with a cylinder radius R is combined with rotationally symmetrical Fresnel structures 9 on the light-exit side. The cylindrical lens form 8 results in a simple manner in the required beam expansion in the horizontal direction H shown in FIG. 2 given a corresponding installation position in the signal.

1-2. (canceled)

3. A light signal, comprising:
a semiconductor light source being a point light source; and
an optical system for representing signal properties, said optical system having an axially symmetrical cylindrical lens and a rotationally symmetrical focusing lens.

4. The light signal according to claim 3, wherein said axially symmetrical cylindrical lens and said rotationally symmetrical focusing lens are an integral plastic injection-molded part.

5. The light signal according to claim 3, wherein said point light source is selected from the group consisting of an individual light-emitting diode (LED) and an individual high-current LED.

6. The light signal according to claim 3, wherein said rotationally symmetrical focusing lens is a Fresnel lens.

7. The light signal according to claim 3, wherein the light signal is used in rail-bound transport routes.
